(19) United States
(12) Patent Application Publication
(10) Pub. No.: US 2026/0058739 A1
(43) Pub. Date: Feb. 26, 2026

(54) ELECTRONIC DEVICE AND METHOD FOR PERFORMING CALIBRATION FOR WIRELESS COMMUNICATION CIRCUIT

(71) Applicant: Samsung Electronics Co., Ltd., Suwon-si (KR)

(72) Inventors: Namjun CHO, Suwon-si (KR); Hyewon JO, Suwon-si (KR); Hyoseok NA, Suwon-si (KR)

(21) Appl. No.: 19/372,010

(22) Filed: Oct. 28, 2025

Related U.S. Application Data
(63) Continuation of application No. PCT/KR2024/005622, filed on Apr. 25, 2024.

(30) Foreign Application Priority Data
Apr. 28, 2023 (KR) 10-2023-0056269
May 26, 2023 (KR) 10-2023-0068334

(51) Int. Cl. H04B 17/13; H04B 17/318

(52) U.S. Cl. CPC H04B 17/13; H04B 17/318

(57) ABSTRACT

An electronic device may comprise: a coupler which is disposed on a wire for connecting an RFFE and an antenna in the wireless communication circuit, and generates a feedback signal of a transmission signal to be transmitted through the antenna; a power detector for providing an output voltage corresponding to the feedback signal provided from the coupler; a feedback reception unit which receives the feedback signal provided from the coupler and is disposed within an RFIC of the wireless communication circuit; and a modem for calculating a first power value of the transmission signal based on the output voltage provided from the power detector, and receiving, from the RFIC, a code value of the feedback signal, the code value being generated based on the feedback signal provided to the feedback reception unit, wherein calibration for at least one element in the wireless communication circuit is performed based on the first power value and the code value.

### CROSS-REFERENCE TO RELATED APPLICATIONS

This application is a continuation of International Application No. PCT/KR2024/005622 designating the United States, filed on Apr. 25, 2024, in the Korean Intellectual Property Receiving Office and claiming priority to Korean Patent Application Nos. 10-2023-0056269, filed on Apr. 28, 2023, and 10-2023-0068334, filed on May 26, 2023, in the Korean Intellectual Property Office, the disclosures of each of which are incorporated by reference herein in their entireties.

### BACKGROUND

### Field

The disclosure relates to an electronic device and a method for performing calibration of a wireless communication circuit.

### Description of Related Art

The wireless communication circuit is an electronic circuit used in a wireless communication device, and is responsible for transmitting/receiving and processing radio signals. The wireless communication circuit is a circuit used to transmit/receive data between an electronic device and a base station by changing data signals into signals at frequencies that can be transmitted to the outside. To support high-frequency band wireless communication, electronic devices have recently been equipped with multiple chipsets as wireless communication circuit modules. In connection with high-frequency band wireless communication technology, it is important to transmit radio frequency (RF) signals at accurate power for a high transmission rate, and distortion occurring in signals while passing through signal paths should be minimized/reduced. In order to prevent signal distortion and deterioration in communication performance, a process of calibrating the wireless communication circuit is required.

### SUMMARY

An example embodiment of the disclosure may provide an electronic device configured to perform calibration of a wireless communication circuit, the electronic device including: a coupler disposed on a wire connecting an antenna and a radio frequency front end (RFFE) comprising circuitry in the wireless communication circuit, and configured to generate a feedback signal of a transmission signal to be transmitted through the antenna; a power detector comprising circuitry configured to receive the feedback signal provided from the coupler and provide an output voltage corresponding to the feedback signal; a feedback receiver comprising circuitry configured to receive the feedback signal provided from the coupler, and disposed inside an RFIC of the wireless communication circuit; and a modem configured to calculate a first power value of the transmission signal output through the antenna, based on the output voltage provided from the power detector, and receive a code value of the feedback signal generated based on the feedback signal provided to the feedback receiver, from the RFIC. In addition, calibration of at least one element in the wireless communication circuit may be performed based on the first power value and the code value.

An example embodiment of the disclosure may provide a method for performing calibration of a wireless communication circuit by an electronic device, the method including: identifying an output voltage of a power detector that has received a feedback signal of a transmission signal to be transmitted through an antenna from a coupler disposed on a wiring connecting the antenna and a radio frequency front end (RFFE) in the wireless communication circuit; calculating a first power value of the transmission signal to be transmitted through the antenna, based on the output voltage; acquiring a code value generated by an RFIC in the wireless communication circuit, based on the feedback signal provided from the coupler to a feedback receiver in the wireless communication circuit; and performing calibration of at least one element in the wireless communication circuit, based on the first power value and the code value.

An example embodiment of the disclosure provides an electronic device configured to perform calibration of a wireless communication circuit, the electronic device including: a coupler electrically connected between an antenna and a power amplifier with integrated duplexer (PAMid) comprising circuitry in a wireless communication circuit configured to generate a feedback signal of a transmission signal to be transmitted through the antenna; a switch configured to receive the feedback signal provided from the coupler; a power detector comprising circuitry configured to receive the feedback signal branched from the switch and provide an output voltage corresponding to the feedback signal; a feedback receiver configured to receive the feedback signal branched from the switch; and a modem configured to calculate a first power value of the transmission signal output through the antenna, based on the output voltage provided from the power detector, and acquire a code value of the feedback signal generated based on the feedback signal provided to the feedback receiver.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments.

FIG. 2 is a block diagram illustrating an example configuration of an electronic device for supporting legacy network communication and 5G network communication according to various embodiments.

FIG. 3 is a block diagram illustrating an example configuration of an electronic device according to various embodiments.

FIG. 4 is a graph illustrating the relationship between the input power and output voltage of a power detector according to various embodiments.

FIG. 5 is a diagram illustrating an example circuit configuration of a power detector according to various embodiments.

FIG. 6 is a diagram illustrating an example of power loss from a power detector to an antenna module in a wireless communication module according to various embodiments.

FIG. 7 is a graph illustrating an example of an effective operation range of a power detector according to various embodiments.

FIG. 8 is a graph illustrating a deviation value of a coupling factor (CF) of a coupler according to various embodiments.

FIG. 9 is a diagram illustrating an example configuration of an electronic device performing calibration, based on a power value of a 6G RF signal to be transmitted through an antenna module, according to various embodiments.

FIG. 10 is a diagram illustrating an example configuration of an electronic device performing calibration, based on a power value of a 6G RF signal to be transmitted through an antenna module, according to various embodiments.

FIG. 11 is a diagram illustrating an example configuration of an electronic device, wherein calibration is performed based on power values of RF signals to be transmitted through multiple antenna modules, and a power detector and a switch are included in an RFIC according to various embodiments.

FIG. 12 is a diagram illustrating an example configuration of an electronic device, wherein calibration is performed based on power values of RF signals transmitted through multiple antenna modules, and a power detector and the switch are disposed outside an RFIC and an RFFE according to various embodiments.

FIG. 13 is a diagram illustrating an example configuration of an electronic device, wherein calibration is performed based on the power values of RF signals transmitted through multiple antenna modules, and a power detector and a switch are disposed in one of multiple RFFEs according to various embodiments.

FIG. 14 is a flowchart illustrating an example method in which an electronic device adjusts the gain of elements in a wireless communication module for calibration according to various embodiments.

FIG. 15 is a flowchart illustrating an example method in which an electronic device calibrates elements in a wireless communication module using a power detector and a feedback receiver according to various embodiments.

### DETAILED DESCRIPTION

Hereinafter, various example embodiments of the disclosure will be described in greater detail with reference to the accompanying drawings. However, the disclosure may be implemented in various different forms and is not limited to the example embodiments set forth herein. In addition, parts irrelevant to the description may be omitted in the drawings for the sake of clarity in describing the disclosure, and like reference numerals have been used to designate like parts throughout the disclosure.

Terms used in the disclosure have been described as general terms currently used in consideration of the functions mentioned in the disclosure, but may be different terms depending on the intention of a person skilled in the art or case law, or the emergence of new technology. Therefore, terms used in the disclosure should not be interpreted merely based on their names, but should be interpreted based on the meanings and the contents of the disclosure as a whole.

In addition, the terms such as first and second may be used to describe various elements, but the elements should not be construed as being limited by the terms. These terms are used to distinguish one element from another.

Throughout the disclosure, when a part is said to be “connected to” another part, the connection may be not only a “direct connection” but also an “electrical connection” with another element interposed therebetween. In addition, when a part is described as “including” a component, the part may further include other components, unless particularly specified otherwise, rather than excluding other components.

The term “in an embodiment” or the like, which appears in various places in the disclosure, does not necessarily refer to the same embodiment.

An embodiment of the disclosure may be represented by functional block elements and various processing steps. Some or all of the functional blocks may be implemented by various numbers of hardware and/or software components that perform specific functions. For example, the functional blocks of the disclosure may be implemented by one or more microprocessors or by circuit elements for predetermined functions. In addition, for example, the functional blocks of the disclosure may be implemented by various programming or scripting languages. The functional blocks may be implemented as algorithms executed in one or more processors. In addition, the disclosure may employ conventional techniques for electronic environment configuration, signal processing, and/or data processing. Terms such as “mechanism,” “element,” “means,” and “component” may be used in a broad manner, and are not limited to mechanical and physical components.

In addition, connection lines or connection elements between components illustrated in the drawings are merely examples for functionally illustrating connections and/or physical or circuit connections. In an actual device, the connection between the components may be indicated by various functional connections, physical connections, or circuit connections that are interchangeable or added.

Hereinafter, the disclosure will be described in greater detail with reference to the accompanying drawings.

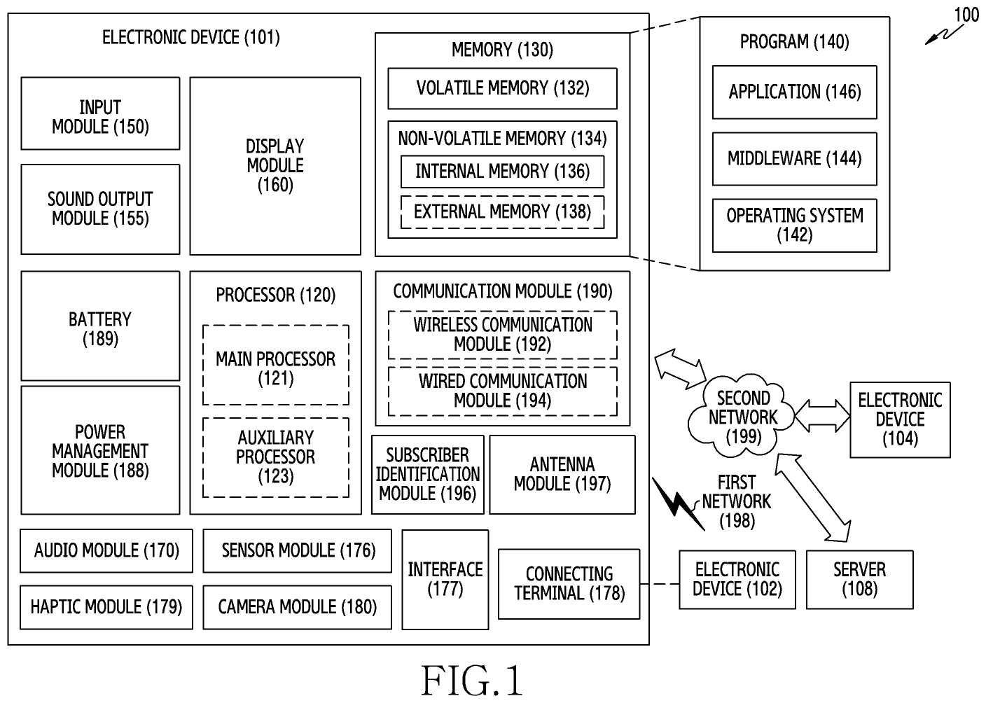

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101.

According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

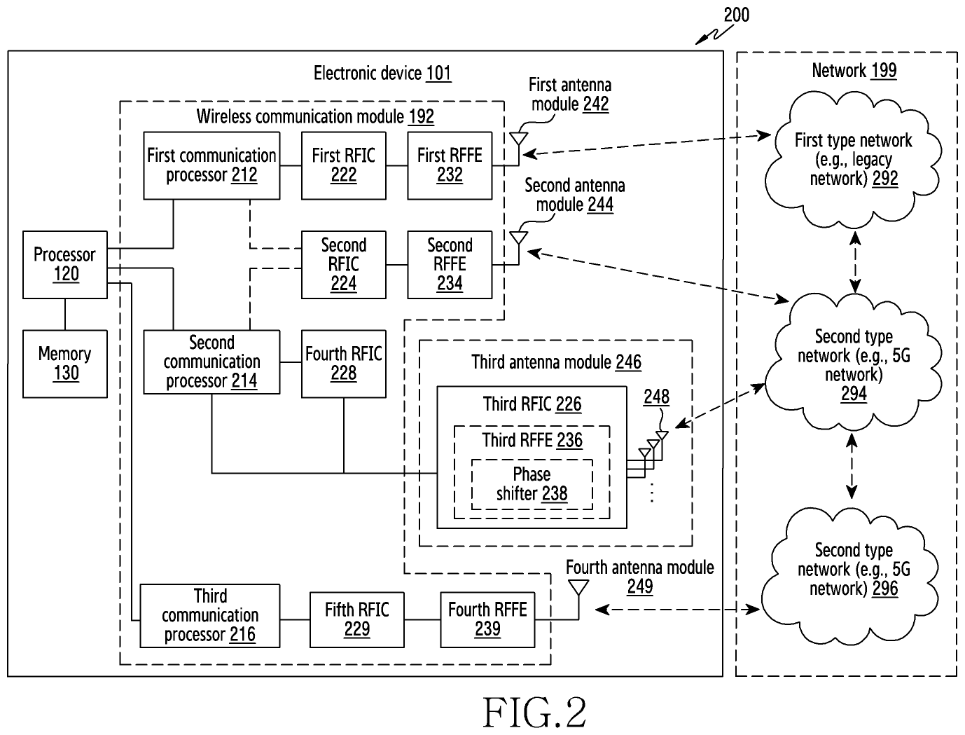

FIG. 2 is a block diagram illustrating an example configuration of an electronic device for supporting legacy network communication and 5G network communication according to various embodiments.

Referring to FIG. 2, the electronic device 101 may include a first communication processor (e.g., including processing circuitry) 212, a second communication processor (e.g., including processing circuitry) 214, a third communication processor (e.g., including processing circuitry) 216, a first RFIC 222, a second RFIC 224, a third RFIC 226, a fourth RFIC 228, a fifth RFIC 229, a first radio frequency front end (RFFE) 232, a second RFFE 234, a fourth RFFE 239, each including various circuitry, a first antenna module (e.g., including at least one antenna) 242, a second antenna module (e.g., including at least one antenna) 244, an antenna 248, and a fourth antenna module (e.g., including at least one antenna)_249. The electronic device 101 may further include a processor (e.g., including processing circuitry) 120 and a memory 130. The second network 199 may include a first type network 292, a second type network 294, and a third type network 296. According to an embodiment, the electronic device 101 may further include at least one of the components illustrated in FIG. 1, and the second network 199 may further include at least one other network. According to an embodiment, the first communication processor 212, the second communication processor 214, the third communication processor 216, the first RFIC 222, the second RFIC 224, the fourth RFIC 228, the fifth RFIC 229, the first RFFE 232, the second RFFE 234, and the fourth RFFE 239 may form at least a part of the wireless communication module 192. According to an embodiment, the fourth RFIC 228 may be omitted or may be included as a part of the third RFIC 226.

The first communication processor 212 may include various processing circuitry and establish a communication channel of a band to be used for wireless communication with the first type network 292, and may support legacy network communication through the established communication channel. The first communication processor 212 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. According to various embodiments, the first type network 292 may be a legacy network including a 2G, 3G, 4G, or long-term evolution (LTE) network. The second communication processor 214 may include various processing circuitry and establish a communication channel corresponding to a specified band (e.g., about 410 MHz to about 100 GHz) among bands to be used for wireless communication with the second type network 294, and support 5G network communication through the established communication channel. The second communication processor 214 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. According to various embodiments, the second type network 294 may be a 5G network defined in 3GPP. Additionally, according to an embodiment, the first communication processor 212 or the second communication processor 214 may establish a communication channel corresponding to a different designated band (e.g., 7.125 GHz or less) among bands to be used for wireless communication with the second type network 294, and support 5G network communication through the established communication channel. According to an embodiment, the first communication processor 212 and the second communication processor 214 may be implemented in a single chip or a single package. According to various embodiments, the first communication processor 212 or the second communication processor 214 may be formed in a single chip or a single package with the processor 120, the auxiliary processor 123, or the communication module 190.

The first RFIC 222 may, during transmission, convert a baseband signal generated by the first communication processor 212 into an RF signal in the range of about 700 MHz to about 3 GHz used in the first type network 292 (e.g., a legacy network). During reception, an RF signal may be acquired through the antenna (e.g., the first antenna module 242) from the first type network 292 (e.g., a legacy network) and may be preprocessed through the RFFE (e.g., the first RFFE 232). The first RFIC 222 may convert the preprocessed RF signal into a baseband signal so as to be processed by the first communication processor 212.

The second RFIC 224 may, during transmission, convert a baseband signal generated by the first communication processor 212 or the second communication processor 214 into an RF signal in a Sub6 band (e.g., 7.125 GHz or less) used in the second type network 294 (e.g., a 5G network) (hereinafter, a 5G Sub6 RF signal, or a frequency range 1 (FR1) signal). During reception, a 5G Sub6 RF signal may be acquired from the second type network 294 (e.g., 5G network) through the antenna (e.g., the second antenna module 244), and preprocessed through the RFFE (e.g., the second RFFE 234). The second RFIC 224 may convert the preprocessed 5G Sub6 RF signal into a baseband signal so as to be processed by a corresponding communication processor among the first communication processor 212 or the second communication processor 214.

The third RFIC 226 may convert a baseband signal generated by the second communication processor 214 to an RF signal in a 5G Above6 band (e.g., about 24.25 GHz to 52.6 GHz) to be used in the second type network 294 (e.g., a 5G network) (hereinafter, a 5G Above6 RF signal, or an FR2 signal). During reception, a 5G Above6 RF signal may be acquired from the second type network 294 (e.g., a 5G network) through the antenna (e.g., the antenna 248) and may be preprocessed through the third RFFE 236. The third RFIC 226 may convert the preprocessed 5G above 6 RF signal into a baseband signal so as to be processed by the second communication processor 214. According to an embodiment, the third RFFE 236 may be formed as a part of the third RFIC 226.

The electronic device 101, according to an embodiment, may include a fourth RFIC 228 separately from or as at least a part of the third RFIC 226. In this case, the fourth RFIC 228 may convert a baseband signal generated by the second communication processor 214 into an RF signal in an intermediate frequency band (e.g., about 9 GHz to about 11 GHZ) (hereinafter, an IF signal), and then transfer the IF signal to the third RFIC 226. The third RFIC 226 may convert the IF signal into a 5G Above6 RF signal. During reception, a 5G Above6 RF signal may be received from the second type network 294 (e.g., a 5G network) through the antenna (e.g., the antenna 248) and may be converted into an IF signal by the third RFIC 226. The fourth RFIC 228 may convert the IF signal into a baseband signal so as to be processed by the second communication processor 214.

The fifth RFIC 229 may, during transmission, convert a baseband signal generated by the third communication processor 216 into an RF signal in a frequency band (e.g., about 7 to 15 GHz or less) used in the third type network 296 (e.g., 6G network) (hereinafter, a 6G RF signal, or a frequency range 3 (FR3) signal). The third communication processor 216 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. During reception, a 6G RF signal may be acquired from the third type network 296 (e.g., 6G network) through the antenna (e.g., the fourth antenna module 249), and may be preprocessed through the RFFE (e.g., the fourth RFFE 239). The fifth RFIC 229 may convert the preprocessed 6G RF signal into a baseband signal so as to be processed by the third communication processor 216.

According to an embodiment, the first RFIC 222 and the second RFIC 224 may be implemented as at least a part of a single chip or a single package. According to an embodiment, the first RFFE 232 and the second RFFE 234 may be implemented as at least a part of a single chip or a single package. According to an embodiment, at least one of the first antenna module 242 or the second antenna module 244 may be omitted or combined with another antenna module to process RF signals in multiple bands corresponding thereto.

According to an embodiment, the third RFIC 226 and the antenna 248 may be disposed on the same substrate to form the third antenna module 246. For example, the wireless communication module 192 or the processor 120 may be disposed on a first substrate (e.g., main PCB). In this case, a third RFIC 226 may be disposed in a partial region (e.g., the lower surface) of a second substrate (e.g., sub-PCB) separate from the first substrate, and an antenna 248 may be disposed in another partial region (e.g., the upper surface) thereof, thereby forming a third antenna module 246. By placing the third RFIC 226 and the antenna 248 on the same substrate, it is possible to reduce the length of the transmission line therebetween. For example, this may reduce the loss (e.g., attenuation) of high frequency band signals used for 5G network communication due to the transmission line. Accordingly, the electronic device 101 may improve the quality or speed of communication with the second type network 294 (e.g., 5G network).

According to an embodiment, the antenna 248 may be configured as an antenna array including multiple antenna elements that may be used for beamforming. In this case, the third RFIC 226 may include, for example, as a part of the third RFFE 236, multiple phase shifters 238 corresponding to the multiple antenna elements. During transmission, each of the multiple phase shifters 238 may convert the phase of a 5G above6 RF signal to be transmitted to the outside (e.g., a base station of a 5G network) of the electronic device 101 through the corresponding antenna element. During reception, each of the multiple phase shifters 238 may convert the phase of a 5G above6 RF signal received from the outside through the corresponding antenna element to the same or substantially same phase. This enables transmission or reception via beamforming between the electronic device 101 and the outside.

The second type network 294 (e.g., a 5G network) may be operated independently of the first type network 292 (e.g., a legacy network) (e.g., stand-alone (SA)) or may be operated in connection therewith (e.g., non-standalone (NSA)). For example, the 5G network may have only an access network (e.g., 5G radio access network (RAN) or next generation (NG) RAN) and no core network (e.g., next generation core (NGC)). In this case, the electronic device 101 may access an external network (e.g., the Internet) under the control of the core network (e.g., evolved packet core (EPC)) of the legacy network after accessing the access network of the 5G network. Protocol information for communicating with a legacy network (e.g., LTE protocol information) or protocol information for communicating with a 5G network (e.g., new radio (NR) protocol information) may be stored in the memory 230, and accessed by another component (e.g., the processor 120, the first communication processor 212, or the second communication processor 214).

The third type network 296 (e.g., a 6G network) may be operated independently of the first type network 292 (e.g., a legacy network) and the second type network 294 (e.g., a 5G network) (e.g., stand-alone (SA) mode) or may be operated in connection therewith (e.g., non-standalone (NSA)).

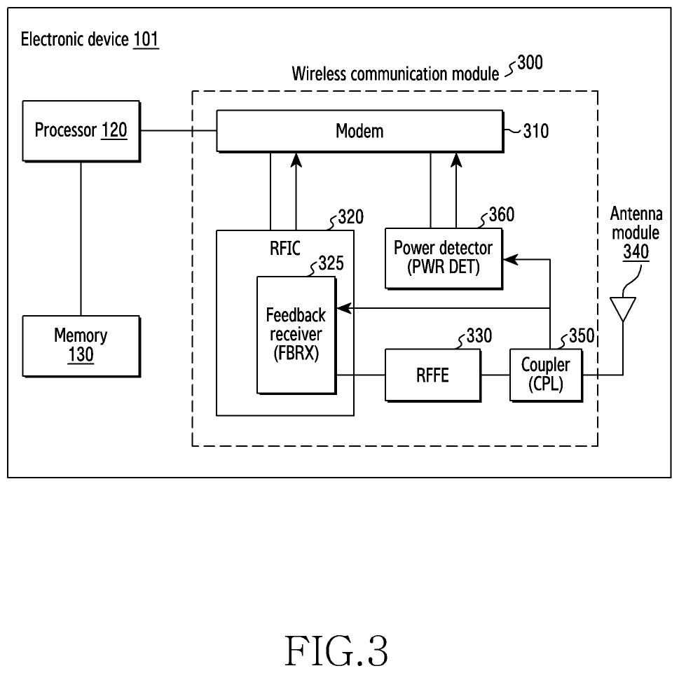

FIG. 3 is a block diagram illustrating an example configuration of an electronic device according to various embodiments.

Referring to FIG. 3, the electronic device 101 according to an embodiment may include a processor (e.g., including processing circuitry) 120, a memory 130, a wireless communication module (e.g., including communication circuitry) 300, and an antenna module (e.g., including at least one antenna) 340. The wireless communication module 300 may include a modem 310, an RFIC 320, an RFFE 330, a coupler 350, and a power detector 360, each of which may include various circuitry.

The processor 120 according to an embodiment may include various processing circuitry and control overall operations of the electronic device 101 by controlling the wireless communication module 300 of the electronic device 101. The processor 120 may control at least one other component (e.g., a hardware or software component) of the electronic device 101 connected to the processor 120, for example, by executing software (e.g., program 140), and may perform various data processing or calculations. As set forth above, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 130 may store various data used by at least one element (e.g., the processor 120 or the sensor module 176) of the electronic device 101. The data may include, for example, software (e.g., programs 140) and input data or output data regarding commands related thereto. The memory 130 may include a volatile memory 132 or a non-volatile memory 134.

The wireless communication module 300 (e.g., the communication module 190 in FIG. 1 or the wireless communication module 192 in FIG. 2) may include various circuitry and establish a wireless communication channel between the electronic device 101 and an external electronic device (e.g., the electronic device 102, the electronic device 104, or the server 108), and may support communication through the established communication channel. The wireless communication module 300 may operate independently of the processor 120 (e.g., application processor), and may include one or more modems supporting direct (e.g., wired) communication or wireless communication. The wireless communication module 300 may support at least one of a 4G network, a 5G network, or a 6G network.

The modem 310 (e.g., the first communication processor 212, the second communication processor 214, or the third communication processor 216 in FIG. 2) may establish a communication channel in a band to be used for wireless communication with at least one of the first type network 292, the second type network 294, and the third type network 296, and may support network communication through the established communication channel.

The modem 310 may convert digital data to be used for wireless communication into a signal of a form suitable for wireless communication, and may transfer the converted signal to the RFIC 320. The modem 310 may, for example, convert digital data into an I/Q baseband signal, and the I/Q baseband signal may be a digital signal or an analog signal. The modem 310 and the RFIC 320 may exchange I/Q baseband signals.

In case that the electronic device 101 transmits signals, the RFIC 320 may convert baseband signals generated by the modem 310 into RF signals in a band used in the network 199. For example, the RFIC 320 may convert I/Q baseband signals to RF signals. In case that the electronic device 101 receives signals, the RFIC 320 may convert RF signals received through the antenna module 340 and preprocessed by the RFFE 330 into baseband signals so as to be processed by the modem 310. For example, the RFIC 320 may convert RF signals into I/Q baseband signals.

In case that the electronic device 101 receives signals, the RFFE 330 may preprocess RF signals received through the antenna module 340. The RFFE 330 may include a power amplifier module with integrated duplexer (PAMid) for amplifying signals.

The antenna module 340 may include at least one antenna and transmit signals or power to the outside (e.g., an external electronic device) or receive the same from the outside.

The coupler 350 may include various circuitry and generate a feedback signal from a transmission signal provided from the RFFE 330 to the antenna module 340. The coupler 350 may output a replica signal of the transmission signal provided from the RFFE 330 to the antenna module 340 as a feedback signal.

According to an embodiment, the coupler 350 may be disposed on an electrical path connecting the antenna module 340 from the RFFE 330. The electrical path for connecting the antenna module 340 to the RFFE 330 may be implemented by, for example, a wire, a PCB, and a conductor, but is not limited thereto. For example, the coupler 350 may be included in a PAMid included in the RFFE 330, or may be disposed between the PAMid and the antenna module 340.

According to an embodiment, the feedback signal output from the coupler 350 may be provided to the power detector 360 and/or the feedback receiver 325 described later. The feedback signal output from the coupler 350 may be selectively provided to the power detector 360 or the feedback receiver 325 by a predetermined switch (not illustrated). The feedback signal output from the coupler 350 may be provided to the power detector 360 and the feedback receiver 325 in parallel.

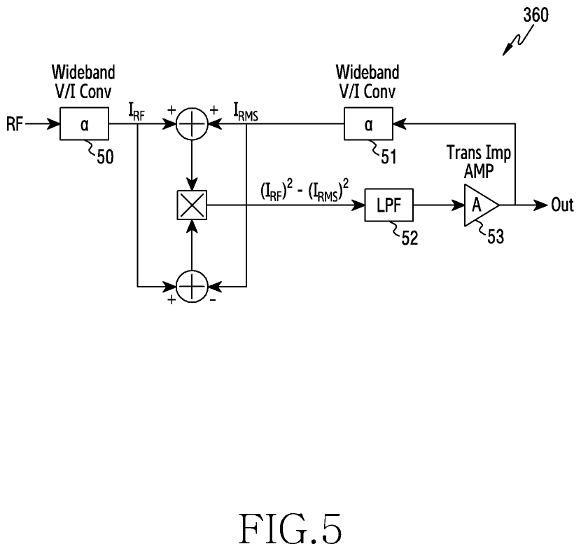

The power detector 360 may include various circuitry and receive a feedback signal provided from the coupler 350, and may provide an output voltage corresponding to the feedback signal using the received input signal. The power detector 360 may be implemented as a circuit having a closed loop structure, including an amplifier having a gain of a predetermined value or more. Using an equation indicating the relationship between the input power of the power detector 360 (e.g., the power of an RF signal input to the power detector 360) and the output voltage thereof, the input power of the power detector 360 may be calculated from the output voltage of the power detector 360. For example, using an equation (e.g., a curve fitting equation) representing the relationship between the input power and the output voltage, which is provided by the manufacturer of the power detector 360, the input power of the power detector 360 may be calculated from the output voltage of the power detector 360. The circuit structure of the power detector 360 according to an embodiment and an output voltage output from the power detector 360 will be described in greater detail below with reference to FIG. 5.

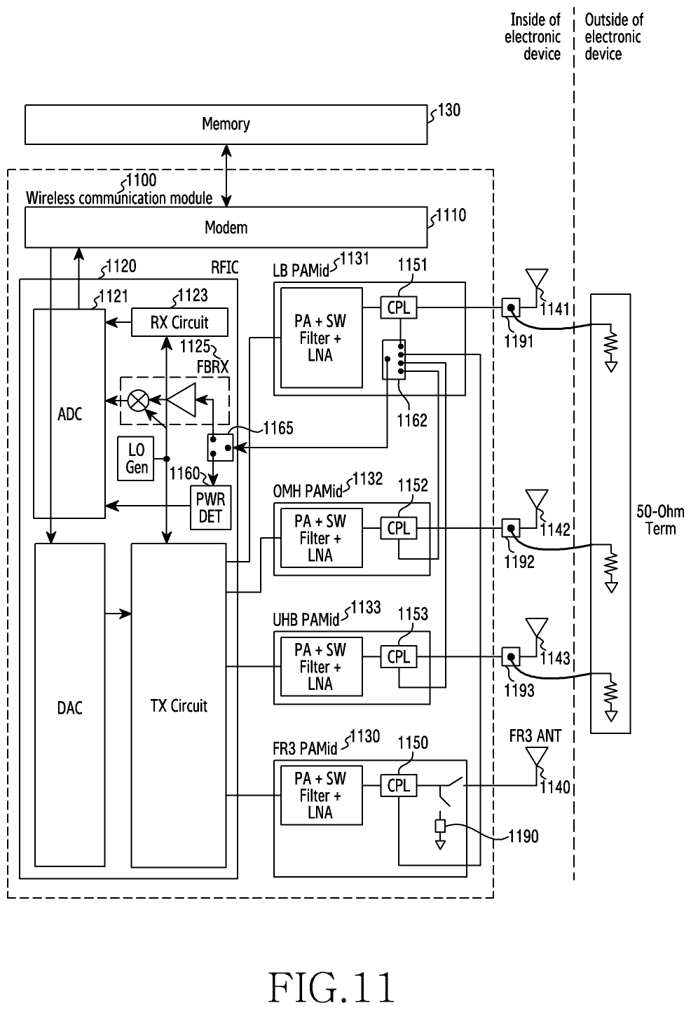

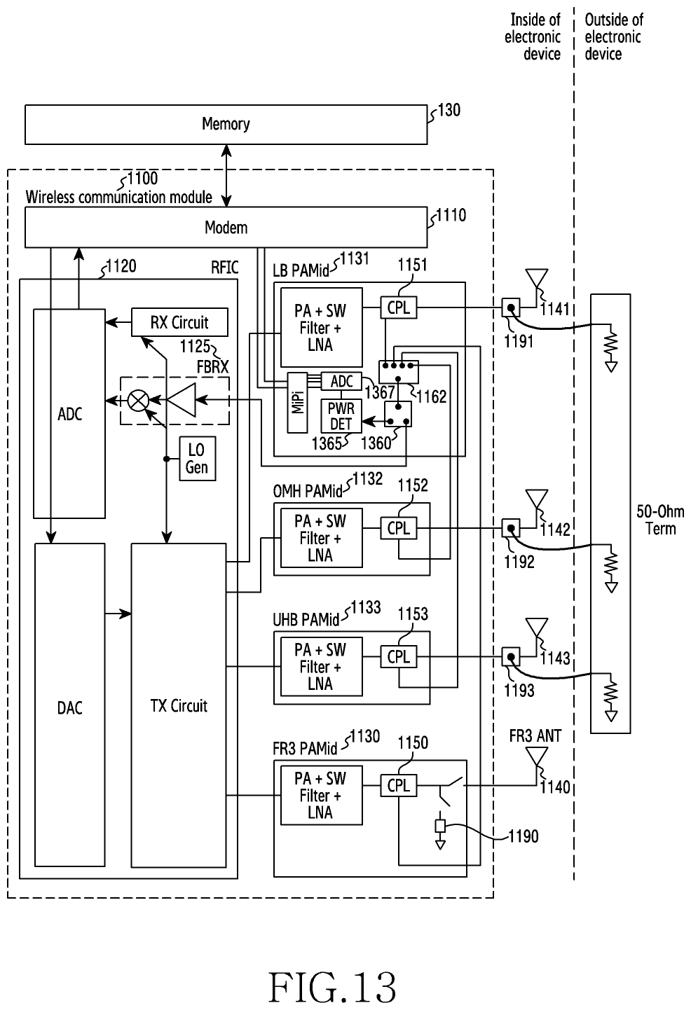

According to an embodiment, the power detector 360 may be disposed outside the RFIC 320 and the RFFE 330, but is not limited thereto. For example, the power detector 360 may be included in the RFIC 320 or included in the RFFE 330. An example in which the power detector 360 according to an embodiment is included in the RFIC 320 or is included in the RFFE 330 will be described later in more detail with reference to FIG. 11 and FIG. 13.

The feedback receiver 325 may include various circuitry and receive a feedback signal provided from the coupler 350. The feedback receiver 325 may provide the feedback signal provided from the coupler 350 to other components inside the RFIC 320. For example, the feedback signal received by the feedback receiver 325 may be amplified, down-converted, and analog-to-digital (ADC) converted by other components inside the RFIC 320, thereby being converted into a code value indicating the power of the feedback signal. For example, the code value indicating the power of the feedback signal may have an I/Q digital code format. For example, a power value in the I/Q digital code format may be acquired from an I/Q waveform acquired through the feedback receiver 325. The code value in the I/Q digital code format may be provided to the modem 310.

The modem 310 may perform calibration of at least one element in the wireless communication module 300, based on the output voltage provided from the power detector 360 and the code value of the feedback signal provided from the RFIC 320 including the feedback receiver 325.

According to an embodiment, the modem 310 may calculate a first power value of a transmission signal output through the antenna module 340, based on an output voltage provided from the power detector 360, may receive a code value of a feedback signal from the RFIC 320 including the feedback receiver 325, and may perform calibration of at least one element in the wireless communication module 300, based on the first power value and the code value. The modem 310 may calculate a second power value, which is based on the feedback signal provided to the feedback receiver 325, by inputting the code value of the feedback signal to <Equation 1> below. <Equation 1> given below may be a function modeled to calculate a second power value of a transmission signal from a code value of a feedback signal. In addition, the modem 310 may perform calibration of elements in the wireless communication module 300, based on the first power value and the second power value.

According to an embodiment, the modem 310 may calculate the magnitude of power of the feedback signal input to the power detector 360 from the output voltage provided from the power detector 360. For example, the modem 310 may calculate the input power of the feedback signal input to the power detector 360 from the output voltage of the power detector 360, using an equation indicating the relationship between the input power and the output voltage. For example, the modem 310 may calculate the input power of the feedback signal input to the power detector 360 from the output voltage of the power detector 360, using an equation (e.g., a curve fitting equation) indicating the relationship between the input power and the output voltage, which is provided by the manufacturer of the power detector 360. An example of calculating the input power of the feedback signal from the output voltage output from the power detector 360 according to an embodiment will be described in greater detail below with reference to FIG. 5.

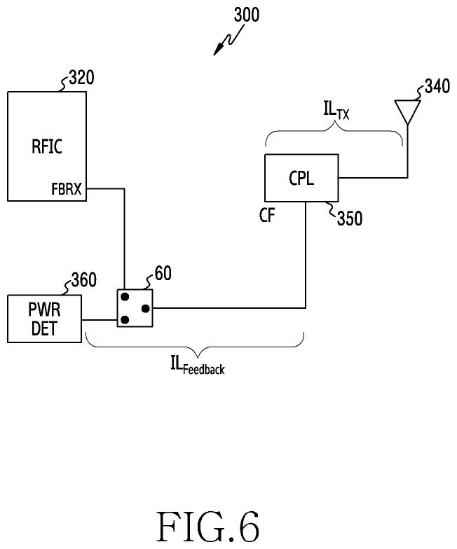

The modem 310 may calculate the first power value of the transmission signal transmitted through the antenna module 340, based on the input power of the feedback signal generated. The modem 310 may calculate the first power value of the transmission signal transmitted through the antenna module 340 from the input power of the feedback signal, by considering the power loss occurring on the electrical path from the power detector 360 to the antenna module 340. An example of calculating the first power value of the transmission signal transmitted through the antenna module 340 from the input power of the feedback signal according to an embodiment will be described in greater detail below with reference to FIG. 6.

The electronic device 101 may generate and store reference data for calibration by control of at least one of the processor 120 or the modem 310.

The electronic device 101 may generate reference data for calibration by storing a first power value and a code value in the memory 130 in a situation in which the power detector 360 is operating effectively. The reference data for calibration may be used to model <Equation 1> given below.

For example, the electronic device 101 may measure the temperature of the electronic device 101 using a temperature sensor in the electronic device 101. In case that the temperature of the electronic device 101 is within a temperature range that allows the power detector 360 to operate effectively, the electronic device 101 may generate reference data for calibration by periodically monitoring the first power value and the code value.

For example, in case that the temperature of the electronic device 101 is within an effective temperature range that guarantees the accuracy of the input power of the power detector 360, and the output voltage of the power detector 360 is within an effective range, the electronic device 101 may generate reference data for calibration by periodically acquiring the first power value and the code value.

For example, in case that the temperature of the electronic device 101 is within a temperature range of a temperature compensation table of the electronic device 101 and is within an effective temperature range that guarantees the accuracy of the input power of the power detector 360, and the output voltage of the power detector 360 is within an effective range, the electronic device 101 may generate reference data for calibration by periodically acquiring the first power value and the code value.

According to an embodiment, the electronic device 101 may generate reference data for calibration, as in <Table 1> below. For example, <Table 1> as the reference data for calibration may record a measured UE temperature (Measured Temp), a code value (e.g., FBRX Digital Code) acquired based on a feedback signal provided to the feedback receiver 325, and a first power value (e.g., PDET Measured TX Pwr) calculated based on the output voltage of the power detector 360.

TABLE 1

| Measured | FBRX | PDET Measured |
|---|---|---|
| Temp (deg C.) | Digital Code | TX Pwr (dBm) |
| −20 | 20664 | 18.6 |
| −18 | 21444 | 18.8 |
| −16 | 20486 | 18.3 |
| . . . | . . . | . . . |
| 10 | 11318 | 18.5 |
| 12 | 18562 | 20.6 |
| 14 | 12161 | 18.8 |
| 16 | 12485 | 18.6 |
| . . . | | |
| 60 | 10845 | 19.4 |
| 62 | 9984 | 18.8 |
| 64 | 9925 | 18.5 |
| 66 | 11295 | 20.8 |

$$TX PWR ( second power value ) = f ( FBRX Digital Code , Temp ) \qquad [ Equation 1 ]$$

According to an embodiment, in a situation where the electronic device 101 is used, the temperature of the electronic device 101, the first power value, and the code value may be periodically measured such that the reference data for calibration is updated, and the equation for calculating the second power value from the temperature of the electronic device 101 and the code value of the feedback signal may be updated, based on the updated reference data. Accordingly, the feedback receiver 325 may be calibrated to accurately monitor the transmission signal output operation under various temperature conditions of the electronic device 101.

According to an embodiment, the electronic device 101 may control at least one of the processor 120 or the modem 310, thereby calibrating at least one element in the wireless communication module 300.

According to an embodiment, the electronic device 101 may configure the gain of the RFIC 320 and the gain of the PAMid in the RFFE 330. The electronic device 101 may configure the gain of the RFIC 320 and the gain of the PAMid in the RFFE 330 to a predetermined default value.

According to an embodiment, the electronic device 101 may output a predetermined digital signal through the modem 310. For example, the predefined digital signal may be a signal of a random data pattern and may be a digital code of a modulated waveform. The digital signal output by the modem 310 may be provided to the RFIC 320, and may be converted to an RF uplink signal of a frequency of the corresponding network by the RFIC 320.

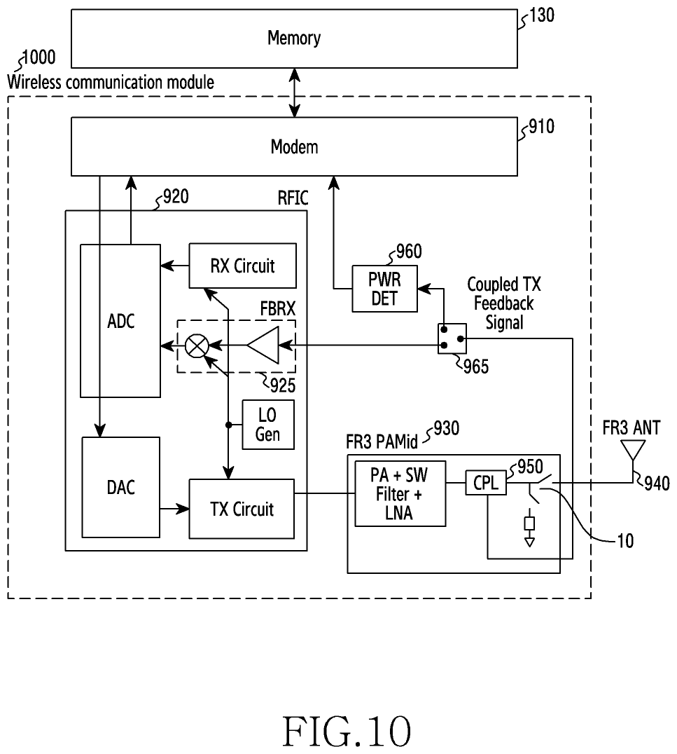

According to an embodiment, the electronic device 101 may cause the switch (e.g., the switch 10 in FIG. 10) between the coupler 350 and the antenna module 340 to be closed. For example, closing of switch 10 may be performed in case of calculating a first power value and a second power value regarding 6G RF transmission signals, but is not limited thereto.

According to an embodiment, the electronic device 101 may configure the switch (not illustrated) between the coupler 350 and the power detector 360 and the feedback receiver 325 such that a feedback signal is provided to the power detector 360. The electronic device 101 may provide a feedback signal provided from the coupler 350 to the power detector 360 by controlling the switch between the coupler 350 and the power detector 360 and the feedback receiver 325. In case that there is no switch (not illustrated) disposed between the power detector 360 and the feedback receiver 325, the feedback signal may be provided in parallel to the power detector 360 and the feedback receiver 325, but is not limited thereto.

According to an embodiment, the electronic device 101 may determine whether the output voltage of the power detector 360 is smaller than a first threshold value. For example, the first threshold may be the minimum value of the range in which the output voltage of the power detector 360 is effective.

According to an embodiment, if the output voltage is smaller than the first threshold, the electronic device 101 may increase the gain of the RFIC 320.

According to an embodiment, if the output voltage is not smaller than the first threshold, the electronic device 101 may determine whether the output voltage of the power detector 360 is greater than a second threshold. For example, the second threshold may be the maximum value of the range in which the output voltage of the power detector 360 is effective.

According to an embodiment, if the output voltage is greater than the second threshold, the electronic device 101 may reduce the gain of the RFIC 320.

According to an embodiment, if the output voltage is not greater than the second threshold, the electronic device 101 may calculate the input power of the feedback signal input to the power detector 360. The electronic device 101 may calculate the magnitude of the power of the feedback signal input to the power detector 360 from the output voltage provided from the power detector 360. For example, the electronic device 101 may calculate the input power of the feedback signal input to the power detector 360 from the output voltage of the power detector 360, using an equation representing the relationship between the input power and the output voltage. For example, the electronic device 101 may calculate the input power of the feedback signal input to the power detector 360 from the output voltage of the power detector 360, using the following <Equation 2>, which represents the relationship between the input power and the output voltage, provided by the manufacturer of the power detector 360.

According to an embodiment, the electronic device 101 may calculate a first power value of a transmission signal to be transmitted through the antenna module 340. The electronic device 101 may calculate a first power value of a transmission signal transmitted through the antenna module 340, based on the input power of the generated feedback signal. The electronic device 101 may calculate a first power value of a transmission signal transmitted through the antenna module 340 from the input power of the feedback signal, by considering the power loss occurring on the path from the power detector 360 to the antenna module 340. The electronic device 101 may calculate a first power value of the transmission signal to be transmitted through the antenna module 340, for example, by considering the input power RFᵢₙ of the feedback signal input to the power detector 360, a loss value IL_{Feedback} from the power detector 360 to the output of the coupler 350, a coupling factor CF of the coupler 350, and a loss value IL_{TX} from the coupler 350 to the antenna module 340. For example, the electronic device 101 may calculate a first power value of a transmission signal to be transmitted through the antenna module using <Equation 6> given below.

According to an embodiment, the electronic device 101 may configure the switch (e.g., the switch 60 in FIG. 6) between the coupler 350 and the power detector 360 and the feedback receiver 325 so that a feedback signal is input to the feedback receiver 325. By configuring the switch between the coupler 350 and the power detector 360 and the feedback receiver 325, a feedback signal may be input to the feedback receiver 325.

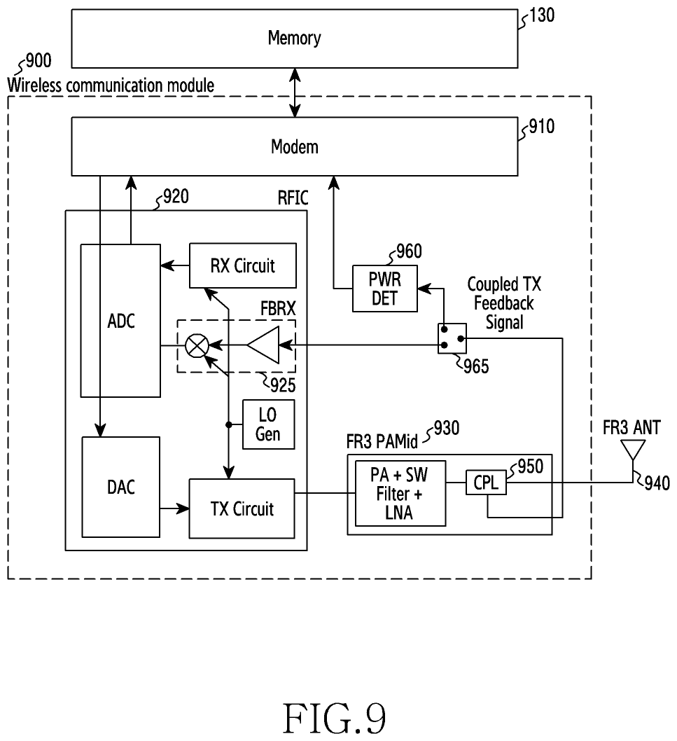

According to an embodiment, the electronic device 101 may acquire a second power value of the feedback signal provided to the feedback receiver 325. The feedback receiver 325 may provide the feedback signal provided from the coupler 350 to other components in the RFIC 320. For example, the feedback signal received by the feedback receiver 325 may be amplified, down-converted, and analog-to-digital converted (ADC) by other components in the RFIC (e.g., the RFIC 320 in FIG. 3, the RFIC 920 in FIG. 9, or the RFIC 1120 in FIG. 11), and thus may be converted into a code value indicating the power of the feedback signal. For example, the code value indicating the power of the feedback signal may have a format of I/Q digital code. The electronic device 101 may acquire a code value of an I/Q digital code format from an I/Q waveform acquired through the feedback receiver.

The electronic device 101 may calculate a second power value based on the feedback signal provided to the feedback receiver by inputting the code value of the feedback signal to <Equation 1>.

According to an embodiment, the electronic device 101 may calculate an offset correction value for calibration. For example, the offset calibration value for calibration may be derived by a difference between the first power value and the second power value. For example, the electronic device 101 may calculate the offset compensation value by subtracting the second power value from the first power value.

According to an embodiment, the electronic device 101 may perform calibration with respect to elements inside the wireless communication module 300, based on the offset calibration value.

According to an embodiment, calibration is performed effectively without separate equipment for calibration, using the first power value calculated based on the power detector 360 having high measurement accuracy but a relatively narrow measurable power range, and the second power value calculated based on the feedback receiver 325 having a wide measurable power range and excellent linear characteristics but a relatively large offset deviation of the power value measured for each UE.

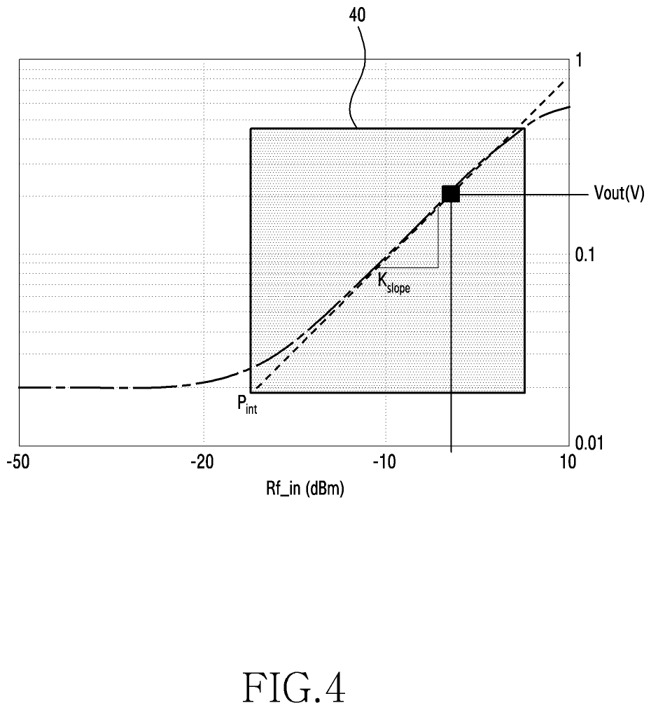

FIG. 4 is a graph illustrating the relationship between the input power and output voltage of a power detector according to various embodiments.

Referring to FIG. 4, the graph in FIG. 4 may represent the relationship between the input power and output voltage of a power detector 360. Referring to the graph in FIG. 4, in the effective range 40, the input power and output voltage of the power detector 360 may have a substantially linear relationship. For example, <Equation 2> below may represent the relationship between the input power and output voltage of the power detector 360 in the effective range 40. For example, <Equation 2> may be a curve fitting equation provided by the manufacturer of the power detector 360.

$${RF}_{in} = ( dBm ) = {V}_{out} / {K}_{slope} + {P}_{int} \qquad [ Equation 2 ]$$

In <Equation 2>, RFᵢₙ may be the input power of the signal input to the power detector 360, Vₒᵤₜ may be the output voltage of the signal output from the power detector 360, Kₛₗₒₚₑ may be the slope in the effective range 40 of the graph in FIG. 4, and Pᵢₙₜ may be the intercept value of the RFᵢₙ axis corresponding to the effective range 40. According to an embodiment, the output voltage of the power detector 360 may be input to <Equation 2>, thereby calculating the input power of the feedback signal input to the power detector.

FIG. 5 is a diagram illustrating an example circuit configuration of a power detector according to various embodiments.

Referring to FIG. 5, the power detector 360 according to an embodiment may comprise a root mean square (RMS) power detector and may be implemented as a circuit having closed-loop structure. The power detector 360 is based on a closed-loop structure for calculating the input power from the output voltage without frequency conversion of the input signal, and the power may thus be stably measured regardless of any deviation of the circuit's gain. For example, the power detector 360 may detect the magnitude of the power by directly measuring the magnitude of the envelope of a signal, without frequency conversion (e.g., down conversion) regarding the input RF signal.

To describe this, it is assumed that the RF input signal of the power detector 360 is V_{RF}*cos (wt), and the output signal of the power detector 360 is V_{RMS}. If the input signal (V_{RF}*cos (wt)) passes through the wideband V/I converter 50 inside the power detector 360, the current of the input signal that has passed may be expressed as I_{RF}=αV_{RF}*cos (wt). In addition, if the output signal (V_{RMS}) passes through the wideband V/I converter 51 inside the power detector 360, the current of the output signal that has passed may be expressed as I_{RMS}=αV_{RMS}.

The conversion coefficient α of the wideband V/I converters 50 and 51 has a large variation, but the same wideband V/I converters 50 and 51 are arranged adjacent to each other inside the circuit, so the difference between the conversion coefficients of the wideband V/I converters 50 and 51 is substantially non-existent. Accordingly, the conversion coefficients of the wideband V/I converter 50 and 51 may be treated equally.

Thereafter, by multiplying the value obtained by adding the I_{RF} signal and the I_{RMS} signal and the value obtained by subtracting the I_{RMS} signal from the I_{RF} signal, the signal input to the low pass filter (LPF) 52 may be calculated as in <Equation 2> below.

$${( {I}_{R F} )}^{2} - {( {I}_{R M S} )}^{2} = α {V}_{R F} {cos ( wt )}^{2} - {( α {V}_{R M S} )}^{2} = ( α {V}_{R F} ) 2 [ 1 / 2 + 1 / 2 cos ( 2 wt ) ] - {( α {V}_{R M S} )}^{2} \qquad [ Equation 3 ]$$

The signal of <Equation 3>, after passing through the LPF 52 and the trans impedance amplifier (53) (e.g., an amplifier having gain A), becomes the output signal of the power detector 360, and the output signal of the power detector 360 may be expressed as <Equation 4> and <Equation 5> below.

$${V}_{RMS} = {α}^{2} A [ {V}_{RF}^{2} / 2 - {V}_{RMS}^{2} ] \qquad [ Equation 4 ]$$

By rearranging Equation 4 under the assumption that the gain of the trans impedance amplifier is sufficiently large (e.g., gain A >>1), the output signal of the power detector 360 may be expressed as in Equation 5 below.

$${V}_{R M S} = {V}_{R F} / 2 \qquad [ Equation 5 ]$$

Referring to <Equation 5> under the assumption that the gain of the trans impedance amplifier is sufficiently large, even if the conversion coefficient α of the wideband V/I converters 50 and 51 inside the power detector 360 or the gain of the trans impedance amplifier 53 has a large deviation, as long as the value is sufficiently large (>>1), a result corresponding to V_{RMS}=V_{RF}/2 may be obtained regardless of the parameter deviation of the circuit of the power detector 360. Accordingly, the power detector 360 may accurately measure the power.

FIG. 6 is a diagram illustrating an example of power loss from a power detector to an antenna module in a wireless communication module according to various embodiments.

Referring to FIG. 6, the first power value PWR_{TX} of the transmission signal transmitted from the antenna module 340 may be calculated, based on the input power RFᵢₙ of the feedback signal input to the power detector 360.

For example, the first power value PWR_{TX} of the transmission signal to be transmitted through the antenna module 340 may be calculated as in <Equation 6> below, by adding the loss value IL_{Feedback} from the power detector 360 to the output of the coupler 350 and the coupling factor (CF) of the coupler 350 to the input power RFᵢₙ of the feedback signal input to the power detector 360, and then subtracting the loss value IL_{TX} from the coupler 350 to the antenna module 340 therefrom.

$${PWR}_{TX} = {RF}_{in} + {IL}_{Feedback} + CF - {IL}_{TX} \qquad [ Equation 6 ]$$

If a switch 60 for branching the feedback signal from the coupler 350 is disposed in the wireless communication module 300, the loss value IL_{Feedback} from the power detector 360 to the output of the coupler 350 may include a trace loss value caused by the wiring on the PCB and a power loss value caused by the switch 60.

The product-to-product deviation of the trace loss value caused by the wiring on the PCB and the power loss value caused by the switch 60 may be maintained within a level of +/−0.3 dB. For example, if the wiring on the PCB is a simple T-line wiring, and if the switch 60 is a passive transistor switch, the deviation of IL_{Feedback} may be insensitive to temperature and product.

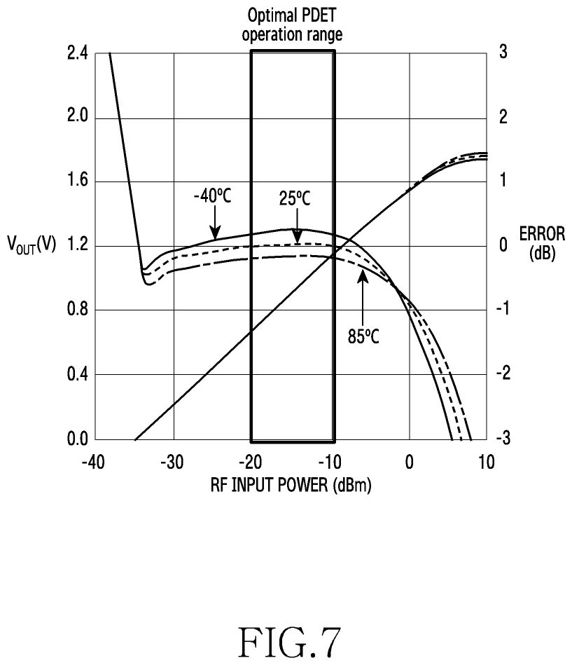

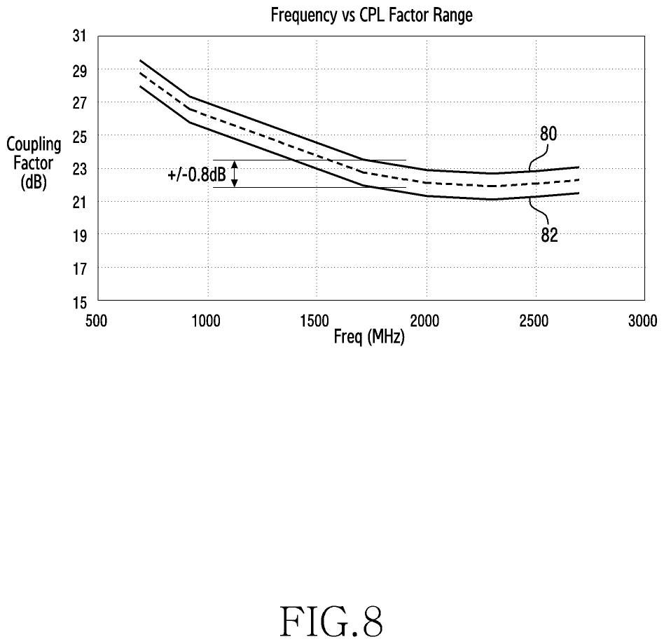

Accordingly, in <Equation 6>, factors contributing to the accuracy of the calculated PWR_{TX} may be the accuracy of the power detector 360 and the deviation of the coupler loss (CF). For example, a review of the effective operation range of the power detector 360 with reference to FIG. 7 confirms that the RF input power of the power detector 360 is in a range of −20 to −10 dBm, and in a wide temperature range of −45 to 85 degrees, the output voltage value of the power detector 360 guarantees an accuracy of within +/−0.3 dB. In addition, a review of the deviation of the CF of the coupler 350 with reference to FIG. 8, for example, confirms that the deviation between the maximum value 80 and the minimum value 82 of the CF of the coupler 350 is within ±0.8 dB.

In consideration of the product-specific deviations of the components used for the first power value calculation according to an embodiment of the disclosure, the RMS error of the TX power calculated in <Equation 1> and <Equation 6> may be 0.9 dB, and the worst case error may be 1.4 dB, and the first power value according to an embodiment of the disclosure may thus have a value which is accurate for calibration.

According to an embodiment, calibration is performed effectively without separate equipment for calibration, using the first power value calculated based on the power detector 360 having high measurement accuracy but a relatively narrow measurable power range, and the second power value calculated based on the feedback receiver 325 having a wide measurable power range and excellent linear characteristics but a relatively large offset deviation of the power value measured for each UE.

According to an embodiment, effective calibration may be performed through accurate power measurement in a wide temperature range, not only during the production process of the electronic device 101 but also in a situation in which the electronic device 101 is used, based on the power detector 360 and the feedback receiver 325.

FIG. 9 is a diagram illustrating an example configuration of an electronic device which performs calibration, based on a power value of a 6G RF signal to be transmitted through an antenna module, according to various embodiments.

Referring to FIG. 9, the electronic device 101 according to an embodiment may transmit a 6G RF signal through a FR3 antenna module 940 for 6G network communication. For example, upon receiving a transmission signal output from the FR3 power amplifier modulated integrated duplexer (PAMid) 930, the coupler 950 may generate a coupled TX feedback signal by replicating the transmission signal. The FR3 PAMid 930 may be configured to be included in the RFFE. The feedback signal generated by the coupler 950 may be provided to the switch 965, and the switch 965 may provide the feedback signal to the power detector (PWR DET) 960 and/or the feedback receiver (FBRX) 925 inside the RFIC 920 by branching the feedback signal.

The modem 910 according to an embodiment may estimate the first power value of a transmission signal to be transmitted through the FR3 antenna module 940, based on the output voltage of a signal output from the power detector 960.

The feedback signal received by the feedback receiver 925 according to an embodiment may be, for example, amplified, down-converted, and analog-to-digital converted (ADC) by other components in the RFIC 920, thereby being converted into a code value indicating the power of the feedback signal. For example, the code value indicating the power of the feedback signal may have the format of an I/Q digital code. The code value of the I/Q digital code format may be provided from the RFIC 920 to the modem 910.

The modem 910 according to an embodiment may store the first power value and the code value in the memory 130, and may perform calibration of at least one element in the wireless communication module 900, based on the first power value and the code value. In this case, for example, the memory 130 storing the first power value and the code value may be a non-volatile memory. The modem 910 may calculate a second power value based on the feedback signal provided to the feedback receiver 925 by inputting the code value of the feedback signal to <Equation 1> above. In addition, the modem 910 may perform calibration of elements within the wireless communication module 900, based on the first power value and the second power value.

In FIG. 9, a 6G antenna designed normally has an impedance close to 50 ohms in the operating frequency range, so that the impedance matching is well performed. Therefore, the wireless communication module 900 in FIG. 9, if used, enables good calibration while an antenna is connected, even without connecting separate equipment.

FIG. 10 is a diagram illustrating an example configuration of an electronic device that performs calibration, based on the power value of a 6G RF signal to be transmitted through an antenna module, according to various embodiments.

Referring to FIG. 10, the wireless communication module 1000 in FIG. 10 may have a structure in which the same further includes a switch 10 between the coupler 950 and the antenna module 940 of the wireless communication module 900 in FIG. 9.

According to an embodiment, in case that calibration is performed while the antenna module 940 is connected, and if radiation of a transmission signal occurs through the FR3 antenna module 940 during the calibration, the transmission signal radiation may cause interference with other operations of the electronic device 101. Therefore, there may be a problem of having to place the electronic device 101 in a shield box that is shielded from the outside in order to perform calibration.

Accordingly, as in FIG. 10, the wireless communication module 1000 according to an embodiment may include a switch 10 for opening the FR3 antenna module 940, and radiation of the transmission signal through the FR3 antenna module 940 may be prevented and/or reduced by opening the switch 10 to calibrate the wireless communication module 1000. For example, the switch 10 may be a term switch, and the connection between the output terminal of the coupler 950 and the FR3 antenna module 940 may be opened using the switch 10, and the output terminal of the coupler 950 and the ground (GND) may be closed using the switch 10, thereby blocking ration of the transmission signal through the FR3 antenna module 940. In this case, the switch 10 may be a one-time switch that provides a switching function only once.

FIG. 11 is a diagram illustrating an example configuration of an electronic device, wherein calibration is performed based on the power value of RF signals to be transmitted through multiple antenna modules, and a power detector and a switch are included in an RFIC according to various embodiments.

Referring to FIG. 11, the RFIC 1120 in the wireless communication module 1100 of the electronic device 101 may be connected to multiple PAMids. For example, the wireless communication module 1100 may be connected to a low-bandwidth PAMid (LM PAMid) 1131, a mid band/high bandwidth PAMid (OMH PAMid) 1132, an ultra-high-bandwidth PAMid (UHB PAMid) 1133), and an FR3 PAMid 1130. However, the number and type of multiple PAMids connected to the RFIC are not limited thereto. In addition, the multiple PAMids 1130, 1131, 1132, and 1133 may be implemented to be included in corresponding RFFEs, respectively.

According to an embodiment, the power detector 1160 may be disposed inside the RFIC 1120. In addition, a switch 1165 for branching a feedback signal to the feedback receiver 1125 and/or the power detector 1160 may be disposed in the RFIC 1120.

According to an embodiment, the first feedback signal generated by the coupler 1151 of the LB PAMid 1131, the second feedback signal generated by the coupler 1152 of the OMH PAMid 1132, the third feedback signal generated by the coupler 1153 of the UHB PAMid 1133, and the fourth feedback signal generated by the coupler 1150 of the FR3 PAMid 1130 may be provided to the switch 1162 inside the LB PAMid 1131. Although the switch 1162 is described as being disposed inside the LB PAMid 1131 in FIG. 11, the disclosure is not limited thereto. For example, the switch 1162 may not be disposed inside the LB PAMid 1131, and may be disposed inside the OMH PAMid 1132, the UHB PAMid 1133, or the FR3 PAMid 1130.

According to an embodiment, the first feedback signal may be a feedback signal of a transmission signal provided from the LB PAMid 1131 to the antenna 1141, the second feedback signal may be a feedback signal of a transmission signal provided from the OMH PAMid 1132 to the antenna 1142, the third feedback signal may be a feedback signal of a transmission signal provided from the UHB PAMid 1133 to the antenna 1143, and the fourth feedback signal may be a feedback signal of a transmission signal provided from the FR3 PAMid 1130 to the antenna 1140.

According to an embodiment, the switch 1162 in the LB PAMid 1131 may provide at least one of the first feedback signal, the second feedback signal, the third feedback signal, or the fourth feedback signal to the switch 1165 in the RFIC 1120.

The switch 1165 in the RFIC 1120 may provide the feedback signal (for example, at least one of the first feedback signal, the second feedback signal, the third feedback signal, or the fourth feedback signal) received from the switch 1162 in the LB PAMid 1131 to the power detector 1160 and/or the feedback receiver 1125. Accordingly, the power detector 1160 may cause a specified value (e.g., a first power value) to be calculated with regard to not only 6G network transmission signals output through the FR3 PAMid 1130, but also transmission signals of other networks output through the LB PAMid 1131, the OMH PAMid 1132, and the UHB PAMid 1133. In addition, calibration of at least one element in the wireless communication module 1100 may be performed in the same method as the method described with reference to FIG. 1 to FIG. 10.

According to an embodiment, an operation calibration of the electronic device 101 may be performed even without connecting separate equipment for calibration to the calibration port 1191 disposed between the LB PAMid 1131 and the antenna module 1141, the calibration port 1192 disposed between the OMH PAMid 1132 and the antenna module 1142, and the calibration port 1193 disposed between the UHB PAMid 1133 and the antenna module 1143. For example, a 50 ohm resistor may be connected to the calibration port 1191, the calibration port 1192, and the calibration port 1193 (50-ohm termination), thereby performing calibration without connecting separate equipment to the calibration port 1191, the calibration port 1192, and the calibration port 1193.

According to an embodiment, the electronic device 101 in FIG. 11 may not include the calibration port 1191, the calibration port 1192, and the calibration port 1193. In this case, the antenna module 1141, the antenna module 1142, and the antenna module 1143 may be used to perform the role of a signal term, thereby performing calibration. For example, by connecting no calibration equipment and by selectively inputting each feedback signal to the power detector 1160 via the switch 1162 and the switch 1165, the first power value and the code value of each transmission signal to be transmitted from each of the antenna modules 1140, 1141, 1142, and 1143 may be acquired, and calibration may be performed based on the first power value and the code value of each transmission signal. For example, the code value of the feedback signal may be input to <Equation 1> so that the second power value based on the feedback signal provided to the feedback receiver 1125 may be calculated. In addition, calibration of the elements within the wireless communication module 1100 may be performed based on the first power value and the second power value.

According to an embodiment, in FIG. 11, since the power detector 1160 and the switch 1165 are embedded inside the RFIC 1120, the power detector 1160 may be implemented together with the CMOS die of the RFIC 1120, thereby reducing the cost required to add the power detector 1160 during manufacturing of the electronic device 101. In addition, the power detector 1160, the feedback receiver 1125, and the RX circuit 1123 may share the ADC 1121 within the RFIC 1120, so that the internal space of the electronic device 101 may be secured and the manufacturing cost of the electronic device 101 may be reduced during manufacturing of the electronic device 101.

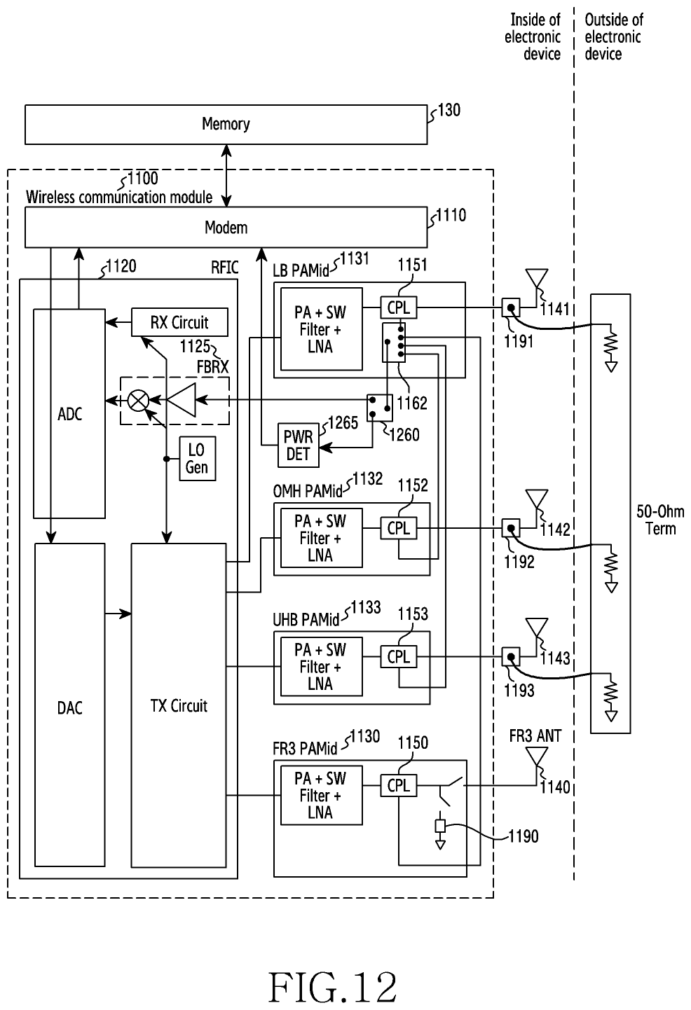

FIG. 12 is a diagram illustrating an example configuration of an electronic device, wherein calibration is performed based on power values of RF signals transmitted through multiple antenna modules, and a power detector and a switch are disposed outside of an RFIC and an RFFE according to various embodiments.

Referring to FIG. 12, the electronic device 101 in FIG. 12 may have a switch 1260 and a power detector 1265 disposed separately outside the RFIC 1120, the LB PAMid 1131, the OMH PAMid 1132, the UHB PAMid 1133, and the FR3 PAMid 1130, compared with the electronic device 101 in FIG. 11.

FIG. 13 is a diagram illustrating an example configuration of an electronic device, wherein calibration is performed based on power values of RF signals to be transmitted through multiple antenna modules, and a power detector and a switch are disposed within one of multiple RFEs according to various embodiments.

Referring to FIG. 13, the electronic device 101 in FIG. 13 may have a switch 1360 and a power detector 1365 disposed in the LB PAMid 1131, compared with the electronic device 101 in FIG. 11. In this case, the length of the wiring for providing the feedback signal to the power detector 1365 may be reduced, the IL_{Feedback} value (uncertainty of a loss value from the power detector to the output of the coupler) in <Equation 6> for calculating the first power value PWR_{TX} of the transmission signal may thus be reduced. In addition, as the ADC 1367 is disposed within the LB PAMid 1131, the reference ground of the output voltage of the power detector 1365 and the reference ground of the ADC 1367 may be brought close to each other, thereby minimizing/reducing the influence of noise due to the ground in connection with conversion of the voltage signal into a digital code.

Although the switch 1360 and the power detector 1365 are described as being disposed in the LB PAMid 1131 with reference to FIG. 13, the disclosure is not limited thereto. For example, the switch 1360 and the power detector 1365 may be disposed in the OMH PAMid 1132 or the UHB PAMid 1133.

According to an example embodiment of the disclosure, an electronic device for performing calibration of a wireless communication circuit (e.g., the wireless communication module 192 in FIG. 2, or the wireless communication module 300 in FIG. 3) may include a coupler (e.g., the coupler 350 in FIG. 3) disposed on an electrical path connecting an RFFE (e.g., the RFFE 330 in FIG. 3) inside the wireless communication circuit and an antenna (e.g., the antenna module 340 in FIG. 3) and configured to generate a feedback signal of a transmission signal to be transmitted through the antenna, a power detector (e.g., the power detector 360 in FIG. 3) configured to receive the feedback signal provided from the coupler and provide an output voltage corresponding to the feedback signal, a feedback receiver (e.g., the feedback receiver 325 in FIG. 3) configured to receive the feedback signal provided from the coupler and disposed in an RFIC of the wireless communication circuit, and a modem (e.g., the modem 310 in FIG. 3) configured to calculate a first power value of the transmission signal output through the antenna, based on the output voltage provided from the power detector, and to receive a code value of the feedback signal generated based on the feedback signal provided to the feedback receiver, from the RFIC. In addition, calibration of at least one element within the wireless communication circuit may be performed based on the first power value and the code value.

According to an example embodiment, the correction value regarding the at least one element may be determined based on the first power value, and a second power value obtained, based on the code value of the feedback signal.

According to an example embodiment, the coupler may generate a replica signal of the transmission signal to be provided to the power detector and the feedback receiver.

According to an example embodiment, the power detector may include a circuit (e.g., 360 in FIG. 5) having a closed loop structure for calculating input power from an output voltage without frequency conversion of an input signal, and may include an amplifier having a gain corresponding to a predetermined numerical value or more.

According to an example embodiment, the modem may calculate the input power of the power detector from the output voltage of the power detector, and may calculate the first power value of the transmission signal, based on the input power and power loss occurring on a path from the power detector to the antenna.

According to an example embodiment, the feedback signal provided to the feedback receiver may be amplified, down-converted, and ADC-converted in the RFIC, thereby being converted into the code value.

According to an example embodiment, the second power value may be calculated by inputting a temperature value of the electronic device and the code value to a function modeled based on reference data for calibration, which is generated within the effective operation conditions of the power detector.

According to an example embodiment, the electronic device may further include a first switch 965, 1165, 1260, 1360 configured to branch the feedback signal provided from the coupler such that the feedback signal is provided to the power detector and the feedback receiver.

According to an example embodiment, the power detector and the first switch may be disposed in the RFIC.

According to an example embodiment, the power detector and the first switch may be disposed in the RFFE.

According to an example embodiment, the power detector and the first switch may be disposed outside the RFIC and the RFFE.

According to an example embodiment, the electronic device may further include a second switch 10, 1190 disposed between the coupler and the antenna, and the second switch may be opened to calculate the first power value and the second power value.

According to an example embodiment, the antenna may be an antenna for 6G network communication.

According to an example embodiment, the electronic device may further include at least one different antenna 1141, 1142, 1143, at least one different RFFE, and a third switch configured to provide the power detector and the feedback receiver with at least one second feedback signal of at least one second transmission signal to be transmitted by the at least one other antenna, and the first feedback signal.

According to an example embodiment, the at least one different antenna is for at least one of 4G network communication or 5G network communication.

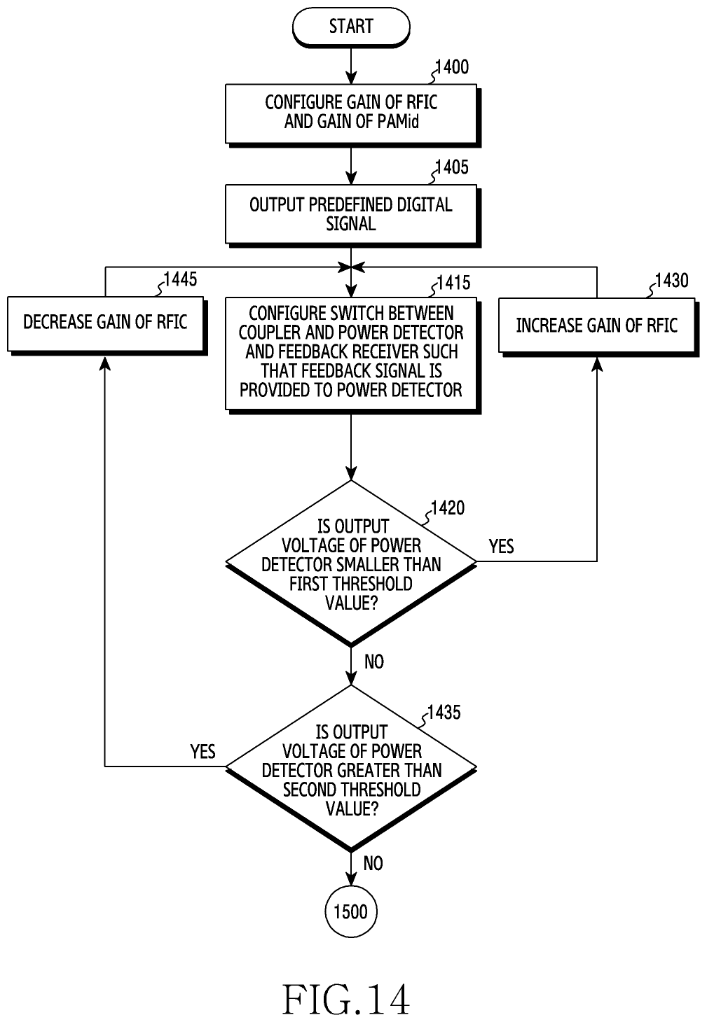

FIG. 14 is a flowchart illustrating an example method in which an electronic device adjusts the gain of elements in a wireless communication module for calibration according to various embodiments.

In FIG. 14, the electronic device 101 may adjust the gain of the RFIC (e.g., 320, 920, 1120) such that the output voltage of the power detector (e.g., 360, 960, 1160, 1265, 1365) becomes a value in the effective range for calibration.

In operation 1400, the electronic device 101 may configure the gain of the RFIC and the gain of the PAMid. The electronic device 101 may configure the gain of the RFIC and the gain of the PAMid to a predetermined default value.

In operation 1405, the electronic device 101 may output a predetermined (e.g., predefined, specified, etc) digital signal through a modem (e.g., 310, 910, 1110). For example, the predetermined digital signal may be a digital code of a modulated waveform as a signal of a random data pattern. The digital signal output by the modem may be provided to the RFIC, and may be converted to an RF uplink signal of the frequency of the corresponding network by the RFIC.

In operation 1415, the electronic device 101 may configure a switch (e.g., 60, 965, 1165) between the coupler (e.g., 350, 950, 1150, 1151, 1152, 1153) and the power detector (e.g., 360, 960, 1160, 1265, 1365) and the feedback receiver (e.g., 325, 925, 1125) to provide a feedback signal to the power detector. The electronic device 101 may provide a feedback signal provided from the coupler to the power detector by controlling the switch between the coupler and the power detector and the feedback receiver.

In operation 1420, the electronic device 101 may determine whether the output voltage of the power detector is smaller than a first threshold value. For example, the first threshold value may be the minimum value of the effective range of the output voltage of the power detector.

If the output voltage is smaller than the first threshold as a result of determination in operation 1420, the electronic device 101 may increase the gain of the RFIC in operation 1430. According to an embodiment, the electronic device 101 may stop transmission of the transmission signal before performing operation 1430, but the disclosure is not limited thereto.

If the output voltage is not less than the first threshold value as a result of determination in operation 1420, the electronic device 101 may determine, in operation 1435, whether the output voltage of the power detector is greater than a second threshold value. For example, the second threshold value may be the maximum value of the effective range of an output voltage of the power detector.

If the output voltage is greater than the second threshold as a result of determination in operation 1435, the electronic device 101 may reduce the gain of the RFIC in operation 1445. According to an embodiment, the electronic device 101 may stop transmission of a transmission signal before performing operation 1445, but the disclosure is not limited thereto.

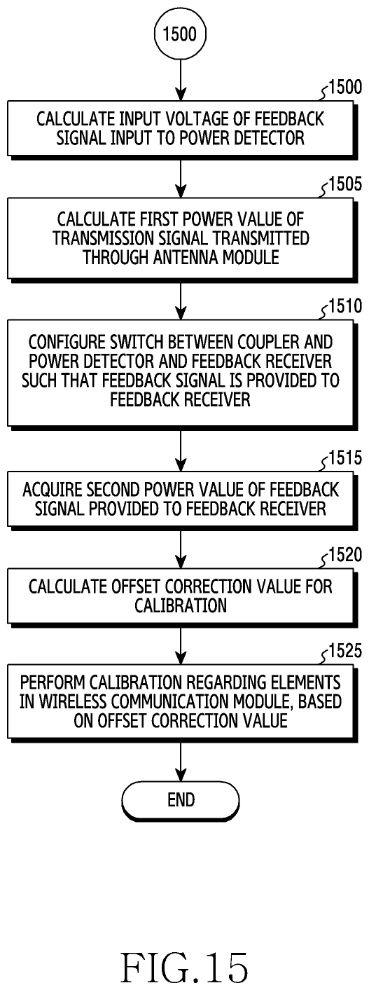

If the output voltage is not greater than the second threshold as a result of determination in operation 1435, the electronic device 101 may perform operation 1500 described in greater detail below with reference to FIG. 15.

FIG. 15 is a flowchart illustrating an example method in which an electronic device calibrates elements in a wireless communication module using a power detector and a feedback receiver according to various embodiments.

In operation 1500, the electronic device 101 may calculate the input power of a feedback signal input to the power detector (e.g., 360, 960, 1160, 1265, 1365). The electronic device 101 may calculate the power of the feedback signal input to the power detector from the output voltage provided by the power detector. For example, the electronic device 101 may calculate the input power of the feedback signal input to the power detector from the output voltage of the power detector, using an equation representing the relationship between the input power and the output voltage. For example, the electronic device 101 may calculate the input power of the feedback signal input to the power detector from the output voltage of the power detector, using <Equation 2> which represents the relationship between input power and output voltage, provided by the manufacturer of the power detector.

In operation 1505, the electronic device 101 may calculate a first power value of a transmission signal to be transmitted through an antenna module (e.g., 340, 940, 1140, 1141, 1142, 1143). The electronic device 101 may calculate a first power value of a transmission signal transmitted through the antenna module, based on the input power of the calculated feedback signal. The electronic device 101 may calculate a first power value of a transmission signal transmitted through the antenna module from the input power of the feedback signal, by considering the power loss occurring on the path from the power detector to the antenna module. The electronic device 101 may calculate a first power value of the transmission signal to be transmitted through the antenna module, for example, by considering the input power RFᵢₙ of the feedback signal input to the power detector, the loss value IL_{Feedback} from the power detector to the output of the coupler (e.g., 350, 950, 1150, 1151, 1152, 1153), the coupling factor (CF) of the coupler, and the loss value IL_{TX} from the coupler to the antenna module. For example, the electronic device 101 may calculate a first power value of a transmission signal to be transmitted through the antenna module using <Equation 6>.

In operation 1510, the electronic device 101 may configure a switch (e.g., 60, 965, 1165) between the coupler and the power detector and the feedback receiver so that a feedback signal is input to the feedback receiver (e.g., 325, 925, 1125). By configuring a switch between the coupler and the power detector and the feedback receiver in operation 1510, a feedback signal may be input to the feedback receiver.

In operation 1515, the electronic device 101 may acquire a second power value of the feedback signal provided to the feedback receiver. The feedback receiver may provide the feedback signal provided from the coupler to other components in the RFIC 320. For example, the feedback signal received by the feedback receiver 325 may be amplified, down-converted, and analog-to-digital converted (ADC) by other components in the RFIC (e.g., 320, 920, 1120), and thus may be converted into a code value indicating the power of the feedback signal. For example, the code value indicating the power of the feedback signal may have a format of I/Q digital code. The electronic device 101 may acquire a code value of an I/Q digital code format from an I/Q waveform acquired through the feedback receiver.

The electronic device 101 may calculate a second power value based on the feedback signal provided to the feedback receiver by inputting the code value of the feedback signal to <Equation 1>.

In operation 1520, the electronic device 101 may calculate an offset correction value for calibration. For example, the offset calibration value for calibration may be derived by a difference between the first power value and the second power value. For example, the electronic device 101 may calculate the offset compensation value by subtracting the second power value acquired in operation 1515 from the first power value calculated in operation 1505.

In operation 1530, the electronic device 101 may perform calibration with respect to elements inside the wireless communication module, based on the offset calibration value. The electronic device 101 may perform, for example, TX sweep, Freq. sweep, and digital pre-distortion (DPD) calibration.

According to an example embodiment, a method of performing calibration of a wireless communication circuit by an electronic device may include: an operation of identifying an output voltage of a power detector (e.g., the power detector 360 in FIG. 3) that has received a feedback signal of a transmission signal to be transmitted through an antenna (e.g., the antenna module 340 of FIG. 3) from a coupler (e.g., the coupler 350 of FIG. 3) disposed on an electrical path that connects an RFFE (e.g., the RFFE 330 in FIG. 3) inside the wireless communication circuit (e.g., the wireless communication module 192 in FIG. 2 or the wireless communication module 300 in FIG. 3) and the antenna; an operation of calculating a first power value of the transmission signal to be transmitted through the antenna, based on the output voltage; an operation of acquiring a code value generated by an RFIC inside the wireless communication circuit, based on the feedback signal provided to a feedback receiver (e.g., the feedback receiver 325 in FIG. 3) inside the wireless communication circuit from the coupler; and an operation of performing calibration with respect to at least one component inside the wireless communication circuit, based on the first power value and the code value.

According to an example embodiment, the operation of calculating the first power value may include calculating the input power of the power detection unit from the output voltage of the power detector, and calculating the first power value of the transmission signal, based on the input power and power loss occurring on the path from the power detector to the antenna.

According to an example embodiment, the method may further include an operation of calculating a second power value of the transmission signal, based on the code value of the feedback signal, and the operation of performing the calibration may include performing the calibration, based on the first power value and the second power value.

According to an example embodiment, the operation of calculating the second power value may include inputting the temperature value of the electronic device and the code value to a function modeled based on reference data for calibration, which is generated within the effective operation condition of the power detection unit, thereby calculating the second power value.

According to an example embodiment, the method may further include an operation of comparing the output voltage and a threshold range, and an operation of changing the gain of the RFIC inside the wireless communication circuit, based on the comparison result.

According to an example embodiment, the operation of calculating the first power value may include, in case that the output voltage is within the threshold range by changing the gain, calculating the first power value of the transmission signal from the output voltage.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device configured to perform calibration of a wireless communication circuit, the electronic device comprising:
a coupler disposed on a wire connecting an antenna and a radio frequency front end (RFFE) comprising circuitry in the wireless communication circuit, and configured to generate a feedback signal of a transmission signal to be transmitted through the antenna;
a power detector comprising circuitry configured to receive the feedback signal provided from the coupler and provide an output voltage corresponding to the feedback signal;
a feedback receiver comprising circuitry configured to receive the feedback signal provided from the coupler, and disposed inside a radio frequency integrated circuit (RFIC) of the wireless communication circuit; and
a modem configured to calculate a first power value of the transmission signal output through the antenna, based on the output voltage provided from the power detector, and receive a code value of the feedback signal generated based on the feedback signal provided to the feedback receiver, from the RFIC,
wherein at least one element in the wireless communication circuit is configured to be calibrated based on the first power value and the code value.

2. The electronic device of claim 1, wherein a correction value of the at least one element is determined based on the first power value, and a second power value calculated based on a code value of the feedback signal.

3. The electronic device of claim 2, wherein the coupler is configured to generate a replica signal of the transmission signal to be provided to the power detector and the feedback receiver.

4. The electronic device of claim 1, wherein the power detector comprises a circuit including a closed loop structure configured to calculate input power from an output voltage without frequency conversion of an input signal, and comprises an amplifier having a gain corresponding to a specified numerical value or more.

5. The electronic device of claim 4, wherein the modem is configured to calculate input power of the power detector from an output voltage of the power detector, and calculate the first power value of the transmission signal, based on the input power and power loss occurring on a path from the power detector to the antenna.

6. The electronic device of claim 5, wherein the second power value is calculated by inputting a temperature value of the electronic device and the code value to a function modeled based on reference data for the calibration generated within an effective operation condition of the power detector.

7. The electronic device of claim 1, further comprising a first switch configured to branch the feedback signal provided from the coupler such that the feedback signal is provided to the power detector and the feedback receiver.

8. The electronic device of claim 7, wherein the power detector and the first switch are disposed in the RFIC.

9. The electronic device of claim 7, wherein the power detector and the first switch are disposed in the RFFE.

10. The electronic device of claim 7, wherein the power detector and the first switch are disposed outside the RFIC and the RFFE.

11. The electronic device of claim 1, further comprising a second switch disposed between the coupler and the antenna,
wherein the second switch is configured to be opened to calculate the first power value and the second power value.

12. The electronic device of claim 1, wherein the antenna includes an antenna configured for 6G network communication.

13. The electronic device of claim 11, further comprising:
at least one different antenna;
at least one different RFFE; and
a third switch configured to provide at least one second feedback signal of at least one second transmission signal to be transmitted by the at least one different antenna, and the first feedback signal to the power detector and the feedback receiver.

14. The electronic device of claim 13, wherein the at least one different antenna includes an antenna configured for at least one of 4G network communication or 5G network communication.

15. A method for performing calibration of a wireless communication circuit by an electronic device, the method comprising:
identifying an output voltage of a power detector that has received a feedback signal of a transmission signal to be transmitted through an antenna from a coupler disposed on a wiring connecting the antenna and a radio frequency front end (RFFE) in the wireless communication circuit;
calculating a first power value of the transmission signal to be transmitted through the antenna, based on the output voltage;
acquiring a code value generated by a radio frequency integrated circuit (RFIC) in the wireless communication circuit, based on the feedback signal provided from the coupler to a feedback receiver in the wireless communication circuit; and
performing calibration of at least one element in the wireless communication circuit, based on the first power value and the code value.

16. The method of claim 15,
wherein the calculating the first power value comprises:
calculating input power of the power detector from an output voltage of the power detector, and calculating the first power value of the transmission signal, based on the input power and power loss occurring on a path from the power detector to the antenna.

17. The method of claim 15, further comprising calculating a second power value of the transmission signal based on the code value of the feedback signal,
wherein the performing the calibration comprises performing the calibration based on the first power value and the second power value.

18. The method of claim 17,
wherein the calculating the second power value comprises:
calculating the second power value by inputting a temperature value of the electronic device and the code value into a function modeled based on reference data for the calibration generated within an effective operation condition of the power detector.

19. The method of claim 17, further comprising:
comparing the output voltage with a threshold range; and
changing a gain of the RFIC in the wireless communication circuit, based on a result of the comparison.

20. The method of claim 19,
wherein the calculating the first power value comprises:
calculating the first power value of the transmission signal from the output voltage, when the output voltage falls within the threshold range due to the change of the gain.
